(19) United States
(12) Patent Application Publication
(10) Pub. No.: US 2020/0300648 A1
(43) Pub. Date: Sep. 24, 2020

(54) Generating a Current Operating Strategy Proposal for a Vehicle

(71) Applicant: Vitesco Technologies GmbH, Hannover (DE)

(72) Inventors: Friedrich Graf, München (DE); Franz Pellkofer, München (DE)

(73) Assignee: Vitesco Technologies GmbH, Hannover (DE)

(21) Appl. No.: 16/651,625

(22) PCT Filed: Sep. 27, 2018
(86) PCT No.: PCT/EP2018/076275

§ 371 Date: Mar. 27, 2020

(30) Foreign Application Priority Data
Sep. 27, 2017 (DE) 10 2017 217 175.8

(51) Int. Cl. G01C 21/34; B60W 40/09; G01C 21/36; G06Q 10/02

(52) U.S. Cl. CPC G01C 21/3469; G06Q 10/02; G01C 21/3617; B60W 40/09

(57) ABSTRACT

Various embodiments include a method for generating a current operating strategy proposal for a motor vehicle, the proposal including a plan to operate the motor vehicle with respect to at least one resource available to the motor vehicle, the method comprising: detecting an individual feature of a potential user of the motor vehicle; selecting user-specific operating information describing how the user usually operates a motor vehicle in relation to the individual feature; determining a current operating requirement for the motor vehicle on the basis of the operating information; determining an amount of the at least one resource currently available to the motor vehicle; comparing the operating requirement with the amount of the at least one resource; and generating the current operating strategy proposal on the basis of the comparison.

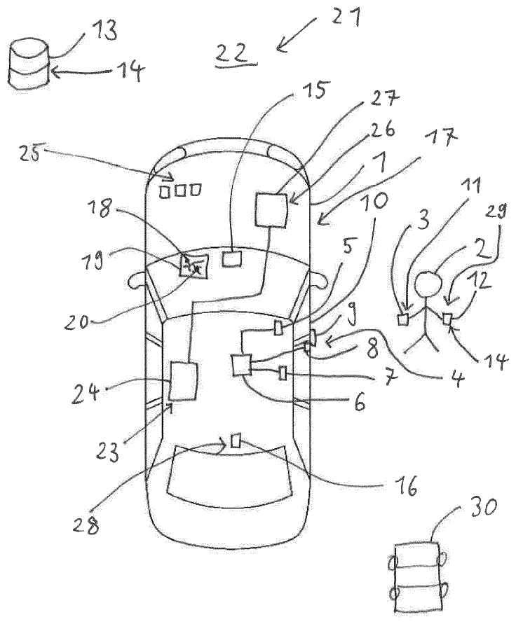

### CROSS-REFERENCE TO RELATED APPLICATIONS

This application is a U.S. National Stage Application of International Application No. PCT/EP2018/076275 filed Sep. 27, 2018, which designates the United States of America, and claims priority to DE Application No. 10 2017 217 175.8 filed Sep. 27, 2017, the contents of which are hereby incorporated by reference in their entirety.

### TECHNICAL FIELD

The present disclosure relates to selecting travel routes. Various embodiments may include methods and/or systems for generating a current operating strategy proposal for a motor vehicle.

### BACKGROUND

Navigation systems of a vehicle may determine, depending on the location of the workplace of a driver of the vehicle, the time of day and the day of the week, that at the end of a working day the driver wants to drive to the home address stored in the navigation system. The navigation system can then immediately suggest the destination, i.e. the location of the home, to the driver without the driver having become active himself. The location of the home can either be taught to the navigation device or navigation system or else the navigation system learns this location by regularly going to this location after work has ended.

### SUMMARY

The teachings of the present disclosure describe methods with which a motor vehicle can be operated more individually. For example, some embodiments include a method for generating a current operating strategy proposal (29) for a motor vehicle (1), which is used to suggest to a user (2) of the motor vehicle (1) how the motor vehicle (1) can be operated with respect to at least one resource (23, 25, 26, 28) available to the motor vehicle (1), with the following steps: a) detecting an individual feature (11) of the user (2) of the motor vehicle (1); b) selecting user-specific operating information (14), which describes how the user (2) usually operates a motor vehicle, on the basis of the individual feature (11); c) determining a current operating requirement (17) of the user (2) for the motor vehicle (1) on the basis of the operating information (14); d) determining the at least one resource (23, 25, 26, 28) currently available to the motor vehicle (1); e) comparing the operating requirement (17) with the at least one resource (23, 25, 26, 28); and f) generating the current operating strategy proposal (29) on the basis of the comparison.

In some embodiments, the individual feature (11) is provided by a mobile transponder (3) carried by the user (2) and is detected by means of a receiver (5) of a door opening device (4) of the motor vehicle (1).

In some embodiments, steps a) to f) are carried out before the user (2) gets into the motor vehicle (1).

In some embodiments, the selected user-specific operating information (14) is provided by a mobile communication terminal (12) of the user (2) and/or a server (13) external to the motor vehicle.

In some embodiments, comfortable temperature information, equipment information, usage information of an entertainment device (15) of the motor vehicle (1), usage information of a cellular data connection (16) of the motor vehicle (1), weekly routine information, daily routine information, weather effect information and/or willingness-to-pay information of the user (2) is selected as the user-specific operating information (14).

In some embodiments, a current destination (18) of the user (2) is input and the current operating requirement (17) of the user (2) for the motor vehicle (1) is determined on the basis of the operating information (14) and the current destination (18).

In some embodiments, on the basis of the current destination (18), energy expenditure for reaching the destination (18), weather conditions between the destination (18) and a current location (20) of the motor vehicle (1), road conditions (21) of a road (22) between the destination (18) and the location (20), a travel time from the location (20) to the destination (18) and/or route information from the location (20) to the destination (18) is/are determined and the current operating requirement (17) of the user (2) for the motor vehicle (1) is determined on the basis of the energy expenditure, the weather conditions, the road conditions, the travel time and/or the route information.

In some embodiments, a state of the energy reserves (23) of a traction energy store (24) of the motor vehicle (1), a state of the equipment (25) of the motor vehicle (1), a power capacity (26) of a traction unit (27) of the motor vehicle (1) and/or a cellular data transmission capacity (28) is determined as the resource.

In some embodiments, the current operating strategy proposal (29) includes provisions for downloading or uploading data as a function of the location and/or the type of radio network available.

In some embodiments, at least one possible route, possible equipment of the motor vehicle (1), a possible capacity restriction of a traction unit (27) of the motor vehicle (1) and/or a necessary energy replenishing stop is suggested by the current operating strategy proposal (29).

In some embodiments, the current operating strategy proposal suggests at least one other motor vehicle (30), which is different from the motor vehicle (1) and which provides the at least one resource at least in accordance with the operating requirement (17).

In some embodiments, the generated operating strategy proposal (29) is output to a charging infrastructure device external to the motor vehicle, which is designed for charging the motor vehicle (1).

In some embodiments, a next-but-one destination that is driven to after a current destination (18) of the user (2) is determined and the current operating requirement (17) of the user (2) for the motor vehicle (1) is determined on the basis of the operating information (14) and the next-but-one destination (18).

In some embodiments, an energy buffer storage requirement of energy external to the vehicle in a traction energy store (24) of the motor vehicle (1) is determined and the current operating requirement (17) of the user (2) for the motor vehicle (1) is determined on the basis of the operating information (14) and the energy buffer storage requirement.

In some embodiments, a pre-bookability of a public charging device for the motor vehicle (1) is determined as the resource.

### BRIEF DESCRIPTION OF THE DRAWING

Exemplary embodiments of the teachings herein are explained in more detail below with the aid of a schematic drawing. The FIGURE shows a schematic plan view of an exemplary embodiment of a motor vehicle incorporating the teachings herein with a door opening device. In the FIGURE, identical or functionally identical elements are provided with the same reference signs.

### DETAILED DESCRIPTION

The teachings of the present disclosure include methods for generating a current operating strategy proposal for a motor vehicle. The operating strategy proposal suggests to a user of the motor vehicle how the motor vehicle can be operated with respect to at least one resource available to the motor vehicle. The following steps may be carried out:
a) detecting an individual feature of the user of the motor vehicle;
b) selecting user-specific operating information, which describes how the user usually operates a motor vehicle, in particular a fictitious motor vehicle, on the basis of the individual feature;
c) determining a current operating requirement of the user for the motor vehicle based on the operating information;
d) determining the at least one resource currently available to the motor vehicle;
e) comparing the operational requirement with the at least one resource; and
f) generating the current operating strategy proposal on the basis of the comparison.

In some embodiments, the method may further comprise: outputting the generated operating strategy proposal, in particular to the user, if the operating strategy proposal is accepted or if consent is needed at all. In some embodiments, outputting the operating strategy proposal to at least one control unit in the motor vehicle and/or to at least one charging station and/or to a service for controlling the charging station and/or to an in-house energy management device in a building and/or to an energy service provider, in particular to know when it is anticipated that the motor vehicle can be used again as a store.

It can then be taken into account for example that the building again uses energy from the motor vehicle's energy store at night and/or the state of charge (SoC) with which the motor vehicle is likely to arrive at the building and/or the state of charge with which the motor vehicle wants to drive again. If the building's energy requirements are acute, it can then also be decided whether the motor vehicle will leave later than originally planned in order to be able to provide the building with the required energy.

When planning the state of charge of the battery or the traction battery of the motor vehicle, this may also include life cycle management because the battery is not always unnecessarily charged to 100% and therefore lasts longer. In some embodiments, the state of charge of the motor vehicle may also be adapted in accordance with the next-but-one period of use. For example, it is not necessary to fully charge the battery because the current period of use does not require 100% of the energy of the fully charged battery and even together with the next-but-one period, does not require 100% of the energy. It may also be the case however that, based on the knowledge of the next-but-one period of use, it is already known that there is enough time to recharge the battery.

In some embodiments, each user of the motor vehicle regularly operates the motor vehicle differently and therefore has different operating requirements for the motor vehicle. The current operating requirement is determined by the knowledge of the operating information, i.e. the knowledge of how the user usually or regularly operates a motor vehicle, i.e. the motor vehicle or another motor vehicle, in particular a fictitious motor vehicle that is formed from a plurality of different motor vehicles.

In some embodiments, before renting the motor vehicle or even before buying the motor vehicle, it can be checked whether the motor vehicle suits the potential user at all and which services would be appropriate, e.g. charging services, in particular rapid charging or DC charging capability, or which configuration of the motor vehicle, such as a change to an electric vehicle, would be appropriate. The operating information is available to the user and includes many possible operating modes of a motor vehicle by the user at different times during the day and/or days of the week and/or weather conditions, while the operating requirement for the motor vehicle applies to the current situation. This means that the operating requirement is obtained in particular when the operating information is combined with for example an indication of the time of day. The information from the operating information for the operating requirement that matches the current situation, for example the ambient temperature, the time of day, the day of the week, the weather conditions and/or the state of health of the user, is therefore selected.

In some embodiments, the user can therefore carry his operating information around with him, for example in his mobile communication terminal, in particular his smartphone or his smart watch, and then for example select a motor vehicle, for example a rental vehicle, and determine the operating requirement for the motor vehicle depending on his operating information. In some embodiments, it is then determined whether the motor vehicle is suitable for the user at all, that is to say whether, in the present current state, it is designed to meet the operating requirement or with what configuration the motor vehicle is designed to meet the operating requirement. This is communicated to the user of the motor vehicle by the generated operating strategy proposal or is output to the latter. In particular, the operating strategy proposal can also be output to at least one control unit of the motor vehicle and/or to a charging infrastructure.

In some embodiments, the traction battery or the energy storage unit of the motor vehicle may also be prepared before operation for the next or next-but-one use. For example, the traction battery may be prepared, for example pre-heated and/or pre-charged, for the forthcoming traction requirement and/or the forthcoming comfort requirements. The operating information also includes for example the use of services and/or a driving style of the user and/or a speed forecast about an expected route and/or a required energy when driving and/or a required energy for the use of the motor vehicle as an energy buffer store, for example for a building or another motor vehicle.

In some embodiments, in the comparison in step e), the difference between the operating requirement and the available resource is determined. If the operating requirement goes beyond the available resource, the operating strategy proposal is either generated in such a way as to advise against taking the motor vehicle, or the restrictions necessary for operating the motor vehicle are pointed out, in order that the operating requirement, that is to say for example a certain driving time, can be met. If the operating requirement appears possible in accordance with the available resource, the operating strategy proposal is generated in such a way that the use of the motor vehicle is possible, preferably without restriction.

In some embodiments, the operating requirement and the resource also include, for example, booked services for charging stations (reservation, access, payment), backend-based services, vehicle-transferable services, provision of the vehicle as an energy store for home and for service providers (when can the motor vehicle be used as an energy store, i.e. when will it not be moved for example), V2D use (V2D—vehicle-to-device). The operating strategy proposal can be used for the user, in particular a driver of the motor vehicle, and/or for specifying requirements to a control unit of the motor vehicle.

In some embodiments, the individual feature is provided by a mobile transponder carried by the user and is detected by means of a receiver of a door opening device of the motor vehicle, in particular in step a). The transponder can therefore be referred to as an electronic key, which preferably has a non-volatile memory. For example, the user-specific operating information may be stored in the non-volatile memory. In some embodiments, the transponder and the receiver are at least temporarily wirelessly coupled. The door opening device is also known as a so-called DHS (DHS—door handle sensor). The door opening device may be used for detecting the individual feature because the motor vehicle is usually unlocked or enabled anyway before beginning to use it and the individual feature can be detected almost simultaneously during this process.

In some embodiments, steps a) to f) are carried out before the user gets into the motor vehicle. It is advantageous to carry out the steps before getting into the motor vehicle because the user then has the possibility also of choosing a different motor vehicle or another motor vehicle before he has got into the motor vehicle, and possibly already made personal adjustments to the motor vehicle, for example the rearview mirror or the seat or the steering wheel. The driver would then have to make these adjustments again in the case of the other motor vehicle. It is also advantageous to carry out steps a) to f) before getting in because a rental agreement for the motor vehicle may not yet have been concluded then and, if the operating requirement of the user cannot be met with the available resources, the user can simply leave it unused without having to worry about the rental agreement and possibly also a rental payment being refunded.

In some embodiments, the user-specific operating information, selected in particular in step b), is provided by a mobile communication terminal of the user and/or a server external to the motor vehicle. In some embodiments, the communication terminal has a memory, in particular a non-volatile memory, on which the operating information of the user is stored. The communication terminal, in particular a smartphone, can then be coupled wirelessly, in particular via Bluetooth or NFC (Near Field Communication), to the motor vehicle in order to transmit the operating information to the motor vehicle or else to transmit the resources of the motor vehicle to the mobile terminal and then carry out the further steps either in the motor vehicle or in the mobile communication terminal.

In some embodiments, user-specific operating information is provided by the server external to the motor vehicle. For example, the motor vehicle may be wirelessly coupled to the server external to the motor vehicle and retrieve the operating information stored on the server or else transmit the available resources to the server, so that the further steps are carried out by the server. Then only the current operating strategy proposal is transmitted from the server to the user and/or the motor vehicle. However, the current operating strategy proposal may also be transmitted to an infrastructure, in particular a charging infrastructure, and/or a building or a house. The transmission to a building is particularly important for the purchasing scenario, that is to say if the operating strategy proposal is intended to inform the user as a potential buyer of the motor vehicle whether the motor vehicle is suitable for him.

In some embodiments, comfortable temperature information, equipment information, usage information of an entertainment device of the motor vehicle, usage information of a cellular data connection of the motor vehicle, weekly routine information, daily routine information, weather effect information and/or user willingness-to-pay information, in particular in step b), is selected as the user-specific operating information.

The comfortable temperature information describes which temperature the user in the motor vehicle interior regularly prefers. The comfortable temperature information can then be used for example to determine how great the difference from an outside temperature currently prevailing in the area surrounding the motor vehicle is and thus how much energy, for example cooling energy or heating energy, is necessary to maintain the interior temperature of the motor vehicle during the operation of the motor vehicle by the user as desired or as usual. The comfortable temperature information may also take the form of a temperature range, for example between 19° C. and 22° C. For example, it may also be planned that, and to what extent, also the next and the next-but-one usage cycle of the motor vehicle is to be supplied with regard to the comfortable temperature information.

The equipment information describes what equipment the motor vehicle has. For example, which driver assistance systems the motor vehicle has, in particular which safety systems the motor vehicle has, which navigation device the motor vehicle has, which communication device the motor vehicle has, how many seats the motor vehicle has, what degree of suspension the motor vehicle has or which functions of the motor vehicle are supported by an electronic actuator, for example electronic window regulators.

The usage information of the entertainment device describes how the user uses the entertainment device of the motor vehicle. For example, there are users who often and/or loudly consume media, in particular music, and therefore consume more energy than for example a user who rarely uses the entertainment device. For example, it may however also be the case that the user would like to receive a specific radio station or television station that cannot be made available as a resource. Then, too, the user's operating requirement is beyond the available resource. In that situation, the operating strategy proposal is then for example output in such a way that the user can use the motor vehicle, but has to expect or accept restrictions with regard to the use of the entertainment device.

The usage information of the cellular data connection describes how often and to what extent the user usually uses the cellular data connection of the motor vehicle. For example, does the user load media, in particular music or films, or does the user regularly check his e-mails while the motor vehicle is in operation, or does the user regularly send larger data packets via the cellular data connection. The usage information of the cellular data connection can also be used, for example, to describe whether the user needs a fast connection, that is, a connection with low response times, or a connection with a high bandwidth, that is to say high throughput values. The weekly routine information specifies for example that the user works from Monday to Friday and has free time on Saturday and Sunday. If the user therefore intends to operate the motor vehicle on a weekday, there are different operating requirements than if the user wanted to operate the motor vehicle at the weekend. For example, the user drives more efficiently in terms of energy at the weekend because he then has more time and does not have to rush from appointment to appointment. Alternatively, it may of course also be the case that the user uses more energy on weekdays because there are important deadlines, or the user is generally more stressed than at the weekend. The daily routine information describes how the user operates the motor vehicle at different times during the day, in particular at different times of day. For example, it may be that the user operates the motor vehicle more energy-efficiently in the morning because he is still a little tired, but it may also be that especially in the morning the driver operates the motor vehicle with a particularly great amount of energy because he wants to get to work quickly. For example, an individual driving style or a speed profile of the driver is also taken into account. An energy profile in which the motor vehicle is parked at home on a day when little energy is consumed by household appliances, and thus more energy is left for the charging process of the motor vehicle, for example at the weekend and not on a washing day, may also be taken into account.

The weather effect information describes in particular how the user of the motor vehicle reacts to different weather situations and how he operates the motor vehicle differently depending on the weather situations. For example, it may be that the user of the motor vehicle operates the motor vehicle more slowly, and thus more energy-efficiently, in the rain than is the case in sunny weather and with a dry road surface. However, it may also be that the driver drives more slowly in the dark or at night, and thus operates the motor vehicle with less energy than is the case during the day.

The willingness-to-pay information describes how much money the user is willing to spend on operating the motor vehicle. For example, the motor vehicle may be in the form of a rental vehicle and the user is for example only willing to pay a certain amount for renting the motor vehicle. If the user is then only willing to pay a certain amount, the motor vehicle may for example be functionally restricted and the functionally restricted version of the motor vehicle may be offered to the user for use. This restricted configuration is then output to the user in particular via the operating strategy proposal. The user can then decide whether the restricted configuration of the motor vehicle is sufficient or whether he does not want to pay more for a more extensive configuration of the motor vehicle or less restricted configuration of the motor vehicle or whether he would like to look around for a different or another motor vehicle right away and does not rent the motor vehicle offered.

In some embodiments, a current destination of the user is specified and the current operating requirement of the user for the motor vehicle is determined on the basis of the operating information and the current destination. For example, the user can specify his destination, in particular before starting the journey, in order that, together with the destination and the operating information, the operating requirement is then determined. This is advantageous because the operating information is based in particular on the usual actions or the regular procedure of the user and thus, for example, an action has to be carried out relatively often in order that it is taken into account in the operating information. Thus, if the user wants to drive to a completely new destination, this cannot for example be suggested or predicted by the operating information. Then, just like the operating information, the destination serves to determine the user's operating requirement for the motor vehicle. The destination may also be guessed, for example by recognizing movement patterns and/or starting patterns and/or destination patterns.

In some embodiments, on the basis of the current destination, energy expenditure for reaching the destination, weather conditions between the destination and a current location of the motor vehicle, road conditions of a road between the destination and the location, a travel time from the location to the destination and/or route information from the location to the destination is/are determined and the current operating requirement of the user for the motor vehicle is determined on the basis of the energy expenditure, the weather conditions, the road conditions, the travel time and/or the route information, in particular in step c). The energy expenditure may for example take the form of electricity consumption or fuel consumption. The energy expenditure then also depends for example on the route, the gradient during the journey to the destination and the road conditions. The current operating requirement of the user for the motor vehicle is determined more precisely by the energy expenditure, the weather conditions, the road conditions, the travel time and/or the route information.

In some embodiments, a state of the energy reserves of a traction energy store of the motor vehicle, a state of the equipment of the motor vehicle, a power capacity of a traction unit of the motor vehicle and/or a cellular data transmission capacity of the motor vehicle is determined as the resource, in particular in step d). The state of the energy reserves describes for example how the state of charge of a battery designed as the traction energy store is or else how full a fuel tank of the motor vehicle is.

The state of the energy reserves describes how much energy the motor vehicle can currently provide without recharging and/or refueling. The state of the equipment describes for example which driver assistance systems are installed in the motor vehicle or else which functions of the motor vehicle are supported or fully carried out by electrical actuators.

The state of the equipment may for example indicate whether the motor vehicle has an infotainment system or an entertainment device or a navigation device or an adaptive cruise control system or a parking assistance device. The state of the equipment may also indicate which data storage capacity and/or which energy storage capacity the motor vehicle has and/or which services the motor vehicle can offer.

The power capacity of the traction unit describes the maximum power that the traction unit can draw if the motor vehicle is configured as intended. For example, it may be that the motor vehicle is configured with a different power capacity, depending on how much money the user is willing to pay for the motor vehicle. For example, the user may only be willing to pay for a certain power capacity. Then the motor vehicle is preferably restricted to the power capacity for which the user is willing to pay. In some embodiments, this restriction takes place by a purely electronic intervention. For example, the user can then only use 50 kW instead of the possible 70 kW. For example, energy buffer storage resources of the motor vehicle may also be enabled or disabled; for example in the case of a rented vehicle or leasing vehicle, the energy buffer storage operation may be disabled or additionally booked for an extra charge.

The cellular data transmission capacity describes the speed and/or the throughput at which data can be transmitted to or from the motor vehicle via the cellular network.

In some embodiments, at least one possible route, possible equipment of the motor vehicle, a possible capacity restriction of a traction unit of the motor vehicle and/or a necessary energy replenishing stop is suggested by the current operating strategy proposal, in particular in step f). The possible route suggests to the user which route is possible in accordance with the operating requirements. For example, it may be that there are different routes to get to the destination. However, it may be that the user can only use some of the routes to the destination in order that the resources are sufficient to meet the operating requirements. The possible route is then for example a route without a pleasant view or else a route which for example is subject to a toll, and is therefore more expensive than an alternative route that is not possible.

The possible equipment describes for example which equipment of the motor vehicle can be suggested to the driver in order that the driver can operate the motor vehicle in accordance with the operating requirements. For example, it may be that the user is not willing to pay enough money to be able to use more than the equipment suggested. However, it may also be that the resources, in particular the energy, are insufficient to be able for example to use an air conditioning system in the motor vehicle as equipment. The possible capacity restriction describes which capacity can be made available to the user in order that the operating requirements are met. If for example the user is only willing to spend a certain amount of money on the rental of the motor vehicle, the performance capacity of the traction unit may be restricted.

In some embodiments, the motor vehicle user is provided with the full power capacity of the motor vehicle, in order that the motor vehicle can for example drive on steep pass roads without any problem. As a result of the necessary energy replenishing stop, it is suggested to the user in particular that the destination cannot be reached with the currently available energy but that an energy replenishing stop is necessary for charging the motor vehicle or for refueling the motor vehicle. Multiple energy replenishing stops may also be necessary. The number of replenishing stops and/or the position and/or duration of the replenishing stops is preferably suggested to the user. For example, it may take a longer time to charge a battery than to fill a fuel tank of the motor vehicle. The motor vehicle may also be designed as a hybrid vehicle and may have both an electric motor and an internal combustion engine as the traction unit.

In some embodiments, the current operating strategy proposal suggests, in particular in step f), at least one other motor vehicle, which is different from the motor vehicle and which provides the at least one resource at least in accordance with the operating requirement. For example, it may be that the motor vehicle, in particular itself with a restriction, cannot meet the operating requirement with its currently available resources. The operating strategy proposal then suggests in particular to the user not to use the motor vehicle, but rather to use the other motor vehicle because this can be operated in accordance with the operating requirement. The other motor vehicle may then for example also be included in a rental car fleet. For example, when the current operating strategy proposal is output, the user is in a large parking lot with rental vehicles and is advised against taking the motor vehicle but is guided to the other motor vehicle, which is for example parked only a few vehicles further away.

In some embodiments, the generated operating strategy proposal is output to a charging infrastructure device external to the motor vehicle that is designed for charging the motor vehicle. The charging infrastructure device may for example be designed as a, in particular private or public, DC charging station and/or AC charging station. The operating strategy proposal may for example be output wirelessly, in particular via a cellular data network.

In some embodiments, an energy buffer storage requirement of energy external to the vehicle in a traction energy store of the motor vehicle is determined and the current operating requirement of the user for the motor vehicle is determined on the basis of the operating information and the energy buffer storage requirement. The energy external to the vehicle is provided for example by a private photovoltaic system or by an energy provider. In some embodiments, the energy is stored in the traction energy store of the motor vehicle when excess energy is being generated (for example in the afternoon). The buffer energy store or the traction energy store can then be discharged again when less energy is generated than is currently being consumed (for example in the evening).

In some embodiments, a pre-bookability of a public charging device for the motor vehicle is determined as the resource. In this way it can be determined whether the public charging device can be reserved for the time of expected arrival at the charging device, and is therefore certain to be available on arrival. For example, some charging devices cannot be booked or reserved at all and other charging devices for example have already been otherwise allocated for the time of arrival.

In some embodiments, the motor vehicle comprises an electric vehicle, a BEV (battery electric vehicle) or PHEV (plug-in hybrid electric vehicle), or else as a mild hybrid vehicle.

The FIGURE shows a motor vehicle 1 in a schematic plan view. A user 2 of the motor vehicle 1 is located next to the motor vehicle 1. According to the exemplary embodiment, the user 2 holds a mobile transponder 3 in his hand. The transponder 3 may for example also be located in a pocket of the user 2 or in a variety of other locations on or near the user 2.

The motor vehicle 1 has a door opening device 4. The door opening device 4 comprises a receiver 5, an evaluation unit 6, an antenna 7 and a proximity sensor 8. The proximity sensor 8 is arranged on a door handle 9 of the motor vehicle 1. According to an exemplary embodiment not shown any more specifically, the motor vehicle 1 may however also be designed without the door handle 9. The proximity sensor 8 may then be arranged at various positions on the motor vehicle 1, e.g. where the (absent) door handle 9 is usually positioned.

An approach to the door handle 9, in particular by a hand of the user 2, is recognized by the proximity sensor 8 and the evaluation unit 6 sends a wake-up signal via the antenna 7 to the transponder 3. The transponder 3 then exchanges information with the receiver 5. If the code of the transponder 3 matches a code in the evaluation unit 6, a door 10 of the motor vehicle 1 is unlocked. The door handle 9 is arranged on the door 10. According to the exemplary embodiment, the door 10 is designed as a driver's door. In particular, the door 10 is a front door, which is arranged on the steering wheel side of the motor vehicle 1. Depending on the design of the motor vehicle 1, the door 10 may thus be arranged on a left side or a right side of the motor vehicle 1.

An individual feature 11 is provided by the transponder 3. The individual feature 11 may for example be stored in the transponder 3 as a unique sequence of numbers.

Furthermore, the FIGURE shows a mobile communication terminal 12 of the user 2 and a server 13 external to the motor vehicle. In some embodiments, the communication terminal 12 comprises a smartphone. The server 13 may be any data server that can provide data, in particular via an Internet connection. User-specific operating information 14 is stored in the communication terminal 12 and/or the server 13. The user-specific operating information 14 describes how the user 2 usually operates the motor vehicle 1 or a variety of other vehicles which can be combined as a fictitious motor vehicle. The operating information 14 is therefore not limited to the motor vehicle 1, but can describe the usage behavior of the user 2 with respect to multiple different motor vehicles. The operating information 14 is therefore user-dependent and different for different users, and therefore individual.

In some embodiments, the operating information 14 describes comfortable temperature information, equipment information, usage information of an entertainment device 15 of the motor vehicle 1, usage information of a cellular data connection 16 of the motor vehicle 1, weekly routine information, daily routine information, weather effect information and/or willingness-to-pay information of the user 2. The operating information 14 may also describe a booked service, an energy flow variable, a driving style or the resulting driving trajectory, a need for comfort, in particular preheating and/or cooling, a most likely route, a pre-booking of an energy store of the motor vehicle 1, in particular as a buffer store, for example by an energy provider, and/or a cargo loading.

In some embodiments, the entertainment device 15 comprises an entertainment system, radio, television or as a media player. The cellular data connection 16 is designed for example for data transmission from the motor vehicle 1 to a cellular transmission mast.

In some embodiments, a current operating requirement 17 of the user 2 for the motor vehicle 1 is determined on the basis of the operating information 14. The operating requirement 17 is determined in particular on the basis of the operating information 14 and a current time during the day and/or a current day. In particular, the part of the operating information 14 that corresponds to the current time during the day or current time of day and the current day and/or for example the current time of year and/or the current weather conditions is thus selected for the operating requirement 17.

The operating requirement 17 then describes the exact requirements the user 2 currently has for the motor vehicle 1 in order to be able to begin using the motor vehicle 1 as desired or as expected.

In some embodiments, the user 2 inputs a current destination 18. The current destination 18 may for example be input into a navigation device 19 of the motor vehicle 1. The navigation device 19 has for example map data for this purpose and is preferably coupled to a global navigation satellite system. By inputting the destination 18, the current operating requirement 17 can also be determined in addition to the operating information 14 on the basis of the current destination 18.

The current destination 18 can additionally determine an energy expenditure for reaching the destination 18, weather conditions between the destination 18 and a current location 20 of the motor vehicle 1. Furthermore, the current destination 18 can determine the operating requirement 17 on the basis of road conditions 21 of a road 22 between the destination 18 and the location 20. The current destination 18 can however also determine a travel time between the destination 18 and the location 20 and/or route information, which describes which route, i.e. which roads, are traveled from the location 20 to the destination 18.

In some embodiments, a state of the energy reserves 23 of a traction energy store 24 of the motor vehicle 1 is determined as a resource of the motor vehicle 1. In some embodiments, a state of the equipment 25 of the motor vehicle 1 is also determined as the resource of the motor vehicle 1. The state of the equipment 25 describes for example which driver assistance devices the motor vehicle 1 has and/or which units of the motor vehicle 1 can be actuated by an electrical actuator. The state of the equipment 25 describes for example whether the motor vehicle 1 has an air conditioning system or even has an automatic climate control and how it is heated, for example how an air flow is oriented, that is to say whether the air flow is directed toward the footwell or whether only radiant heat from an infrared heater is used. Furthermore, a power capacity 26 of a traction unit 27 of the motor vehicle 1 is determined as the resource. The power capacity 26 indicates for example what maximum power, for example in kW, the traction unit 27 can provide. However, a cellular data transmission capacity 28 is also determined as the resource. The cellular data transmission capacity 28 describes the speed at which a specific amount of data can be transmitted.

A comparison is made between the operating requirement 17 and at least one of the resources 23, 25, 26, 28. A current operating strategy proposal 29 is generated on the basis of the comparison. According to the exemplary embodiment, the operating strategy proposal 29 suggests a possible route, possible equipment of the motor vehicle 1, a possible capacity restriction of the traction unit 27 and/or a necessary energy replenishing stop. The energy replenishing stop is for example a stop at a gas station for refilling with fuel and/or recharging electrical energy.

The operating strategy proposal 29 may however also suggest to the user 2 that the motor vehicle 1 does not meet his operating requirement 17 and that another motor vehicle 30 better matches his operating requirement 17. The other motor vehicle 30 then preferably provides at least one resource sufficiently that the operating requirement 17 of the user 2 can be met at the current time.

The operating strategy proposal 29 may for example be output to the user 2 via the communication terminal 12. The operating strategy proposal 29 may for example also be generated in the communication terminal 12 or else in the server external to the vehicle or else in the motor vehicle 1.

The motor vehicle 1 may for example be configured as a motor vehicle that can be operated at least partially autonomously or a motor vehicle that can be operated fully autonomously. The state of the equipment 25 of the motor vehicle 1 may for example also include a traffic light predicting device or a traffic light predicting service.

The presence of the operating information 14 means that, when the motor vehicle 1 begins to be used by the user 2, it can also be continued, for example in the case of a radio program or a podcast, at the point at which the user 2 had stopped listening the last time.

An air conditioning compressor of the motor vehicle 1 may also be included as the resource. The operating strategy proposal 29 may then for example also output an optimized operating strategy for driving the air conditioning compressor. This is particularly advantageous if the air conditioning compressor can be driven as a hybrid, that is to say both by the internal combustion engine and by an electric motor. Downtimes of the vehicle, and thus of the internal combustion engine, for example before traffic lights, can be predetermined. In this case the electric drive is necessary. The electrical energy can then be better determined in advance on the basis of the predefined route and also the climatic conditions, but also the comfort requirements of the individual driver. The electrical energy can then be generated before demand and stored in the store when it can be generated at the lowest cost and best efficiency of the internal combustion engine, but also on downhill gradients.

Since the route can be predetermined, dead spots or the general availability of transmission rates can be determined in advance as a function of the location and the type of radio network available. Large amounts of data can be downloaded or uploaded prior to the occurrence of bottlenecks before they are needed when you are in the “dead zone”. This means that data from services are available when you need them or they have previously been shared, for example with other vehicles. Data can also be transferred at the lowest cost if the vehicle continuously stores information locally, for example in a map. On the next trip on the same route, access then takes place for example at a location with free WLAN.

### LIST OF REFERENCE SIGNS

1 Motor vehicle
2 User
3 Transponder
4 Door opening device
5 Receiver
6 Evaluation unit
7 Antenna
8 Proximity sensor
9 Door handle
10 Door
11 Individual feature
12 Communication terminal
13 Server
14 Operating information
15 Entertainment device
16 Cellular data connection
17 Operating requirement
18 Destination
19 Navigation device
20 Location
21 Road conditions
22 Road
23 State of the energy reserves
24 Traction energy store
25 State of the equipment
26 Power capacity
27 Traction unit
28 Cellular data transmission capacity
29 Operating strategy proposal
30 Other motor vehicle

What is claimed is:

1. A method for generating a current operating strategy proposal for a motor vehicle, the proposal including a plan to operate the motor vehicle with respect to at least one resource available to the motor vehicle, the method comprising:
detecting an individual feature of a potential user of the motor vehicle;
selecting user-specific operating information, describing how the user usually operates a motor vehicle in relation to the individual feature;
determining a current operating requirement for the motor vehicle on the basis of the operating information;
determining an amount of the at least one resource currently available to the motor vehicle;
comparing the operating requirement with the amount of the at least one resource; and
generating the current operating strategy proposal on the basis of the comparison.

2. The method as claimed in claim 1, wherein the individual feature is provided by a mobile transponder carried by the user and is detected by a receiver of a door opening device of the motor vehicle.

3. The method as claimed in claim 1, wherein the current operating strategy proposal is generated before the user gets into the motor vehicle.

4. The method as claimed in claim 1, wherein the selected user-specific operating information is provided by a mobile communication terminal of the user and/or a server external to the motor vehicle.

5. The method as claimed in claim 1, wherein the user-specific operating information comprises at least one datum selected from the group consisting of: comfortable temperature information, equipment information, usage information of an entertainment device of the motor vehicle, usage information of a cellular data connection of the motor vehicle, weekly routine information, daily routine information, weather effect information and/or willingness-to-pay information of the user.

6. The method as claimed in claim 1, further comprising receiving a current destination of the user and determining the current operating requirement for the motor vehicle on the basis of the operating information and the current destination.

7. The method as claimed in claim 6, further comprising:
determining, on the basis of the current destination, at least one datum selected from the group consisting of: energy expenditure for reaching the destination, weather conditions between the destination and a current location of the motor vehicle, conditions of a road between the destination and the location, a travel time from the location to the destination, and route information from the location to the destination; and
determining the current operating requirement of the user for the motor vehicle on the basis of the energy expenditure, the weather conditions, the road conditions, the travel time, and/or the route information.

8. The method as claimed in claim 1, wherein the resource includes at least one of: a state of the energy reserves of a traction energy store of the motor vehicle, a state of the equipment of the motor vehicle, a power capacity of a traction unit of the motor vehicle, or a cellular data transmission capacity.

9. The method as claimed in claim 8, wherein the current operating strategy proposal includes provisions for downloading or uploading data as a function of the location and/or the type of radio network available.

10. The method as claimed in claim 1, wherein the current operating strategy proposal includes: a possible route, possible equipment of the motor vehicle, a possible capacity restriction of a traction unit of the motor vehicle, and/or a necessary energy replenishing stop.

11. The method as claimed in claim 1, wherein the current operating strategy proposal includes a suggested alternative motor vehicle different from the motor vehicle; and
the alternative motor vehicle provides the resource in accordance with the operating requirement.

12. The method as claimed in claim 1, further comprising transmitting the generated operating strategy proposal to a charging infrastructure device external to the motor vehicle, which is designed for charging the motor vehicle.

13. The method as claimed in claim 1, further comprising:
determining a next-but-one destination that is driven to after a current destination of the user; and
determining the current operating requirement of the user for the motor vehicle on the basis of the operating information and the next-but-one destination.

14. The method as claimed in claim 1, further comprising:
determining an energy buffer storage requirement of energy external to the vehicle in a traction energy store of the motor vehicle; and
determining the current operating requirement of the user for the motor vehicle on the basis of the operating information and the energy buffer storage requirement.

15. The method as claimed in claim 1, wherein the resource comprises a pre-bookability of a public charging device for the motor vehicle.
